(19) United States
(12) Patent Application Publication
(10) Pub. No.: US 2015/0341225 A1
(43) Pub. Date: Nov. 26, 2015

(54) DIRECT NETWORK TRACKING AND MARKETING TOOLS

(71) Applicant: Access Business Group International LLC, Ada, MI (US)

(72) Inventors: David W. Baarman, Fennville, MI (US); Cody D. Dean, Grand Rapids, MI (US)

(73) Assignee: ACCESS BUSINESS GROUP INTERNATIONAL LLC, Ada, MI (US)

(21) Appl. No.: 14/285,593

(22) Filed: May 22, 2014

(51) Int. Cl. H04L 12/24; G06Q 10/08; H04L 12/26

(52) U.S. Cl. CPC H04L 41/145; H04L 41/12; H04L 43/065; G06Q 10/0833

(57) ABSTRACT

A system is disclosed for tracking and modeling a network. A graphical model of one's network may be useful for tracking information about that network. The tracking system may include the assignment of a unique identifier (“ID”) to each node (e.g. person) within a network. The ID for each node may include information about that node. For example, a prefix/preamble or postfix/postamble added as part of the ID may identify other members connected to that node, such as an upline or downline in an MLM network. An interface (e.g. website) may receive information about a particular node for generating the ID for other nodes in that network. The network tracking may be applied to tracking a product or package utilizing a similar ID (e.g. on a tag) that can be read from or written to so that the ID can record interactions with the product/package.

### RELATED APPLICATION

This application is related to U.S. Ser. No. 13/108,691, entitled “DATA COLLECTION, TRACKING, AND ANALYSIS FOR MULTIPLE MEDIA INCLUDING IMPACT ANALYSIS AND INFLUENCE TRACKING,” which was filed on May 16, 2011, the entire disclosure of which is hereby incorporated by reference.

### BACKGROUND

Marketing in various business models may include maintaining connections within a network. Those connections may be through different sources (personal, business, etc.). For example, in a multi-level marketing (“MLM”) business, a network for a seller may include an upline and a downline. Tracking and modeling this network may be useful for marketing.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates a block diagram of an exemplary computing system;

FIG. 2 illustrates exemplary identifier information;

FIG. 3 illustrates additional exemplary identifier information;

FIG. 4 illustrates an exemplary network for the identifier information;

FIG. 5 illustrates an exemplary web interface for interacting with the identifier;

FIG. 6 illustrates a device example for network tracking;

FIG. 7 illustrates a business example for network tracking;

FIG. 8 illustrates a blogger example for network tracking;

FIG. 9 illustrates a survey example for network tracking;

FIG. 10 illustrates identifier tagging of a product;

FIG. 11 illustrates another embodiment of identifier tagging of a product;

FIG. 12 illustrates an exemplary flow in a sales network; and

FIG. 13 illustrates the linking of data in a sales network.

### DETAILED DESCRIPTION

By way of introduction, the disclosed embodiments relate to system and methods for tracking and modeling a network. A graphical model of one's network may be useful for tracking information about that network. The tracking system may include the assignment of a unique identifier (“ID”) to each node (e.g. person) within a network. The ID for each node may include information about that node. For example, a prefix/preamble or postfix/postamble added as part of the ID may identify other members connected to that node, such as an upline or downline in an MLM network. An interface (e.g. website) may receive information about a particular node for generating the ID for other nodes in that network. The network tracking may be applied to tracking a product or package utilizing a similar ID (e.g. on a tag) that can be read from or written to so that the ID can record interactions with the product/package.

As described, a network may refer to any connections between nodes. In an example used through the disclosure, each node represents one individual and the connections represent contacts/interactions with other individuals who are independent nodes in the network. The connections in the network may reveal the separation between individuals. Six degrees of separation is one method for estimating the distance between relationships/connections within a population segment. The direct sales or MLM business utilizes these relationships as a marketing channel. Accordingly, a visual representation of one's network may be useful for marketing purposes. Each person may monitor and track their personal network which can be used to produce valuable information about the network or about consumer needs. These network tracking and marketing tools may be utilized by businesses, organizational structures, churches, etc. This network may be supplement to or a summary/combination of other social networking tools like Twitter, Facebook and MySpace, etc.

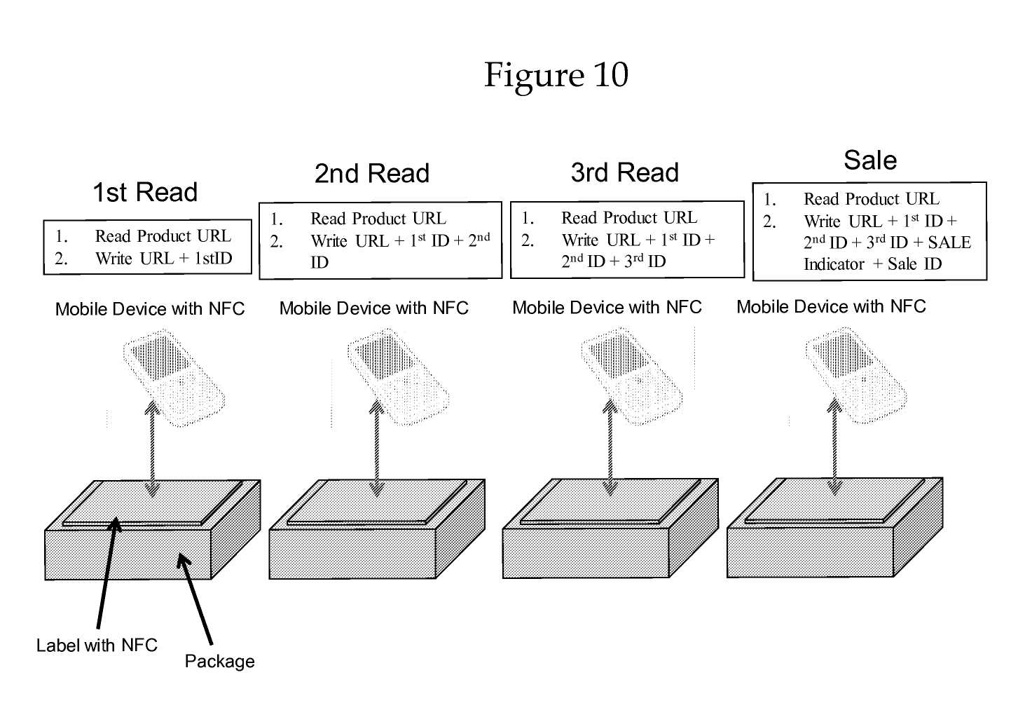

A network may include a collection of people. In addition, a (computer) network is also described below and includes any connection of computing devices, such as the Internet. However, the network tracking described in this application refers to tracking people in a collection of people. In alternative embodiments, the principles discussed herein may apply to other interconnected networks of objects, rather than just people. For example, a package or product that travels through nodes (e.g. locations/people/places) may be tracked as described with respect to FIG. 10 below. For simplicity, the network will be described as a collection of people throughout this disclosure. The network may include different bounds (e.g. friend network, social media network, work network, device network, school network, hobby network, sport network, religion network, customer network, etc.). The network may be anything that connects people. The work network may distinguish people by their work title. A device network may distinguish people by what device they sent a message with. Each person in a network can be described by a point called a node and when a person communicates with another person in the network they have a connection which is a line between the points called an edge. A network may be a group of nodes connected by edges and this representation may be referred to as a graph.

The generation of a graph may be referred to as modeling a network because the network is graphically represented. In one embodiment, the graph is generated such that every node in is separated by two degrees of separation or less. The graph may be a complete bipartite graph, which means that the nodes are split into two groups A and B and each node in A is connected to every node in B and none of the nodes in A are connected to each other, and vice versa. One example of this would be to take 3 million people or nodes and split them into groups of 1 and 2,999,999. The 1 node would be connected to every other node. This graph may be 1 boss and 2,999,999 employees. Alternatively, the split may be into groups of 1.5 million each but that would not represent a work network either.

Assuming there is an original group of n people. In a work network, the n people may be the board of directors of a company, or the president and vice president, such that everyone in this group is connected with an edge which indicates that they are separated by one degree of separation. Sending a message (or other communication/interaction) to everyone in the network may include each of the n people sending the message to the x people that work under them, and these x people sending the message to the x people under them. One assumption that is made is that the number of people that work under someone is that same for each boss, which is unlikely to be the case, but it simplifies the math. So each time the message is sent to a new group this may be considered a new level. So level 1 is the president and vice president, level 2 are the VPs of each branch of the company, level 3 are the directors, then the managers, etc. To give one an idea of how quickly this reaches people say at level 1, if you only start with 3 people and they each send the message to 7 people, then these people send to 7. At level 8, this reaches almost 3 million people and at level 9 it reaches over 20 million. Also at level 8 there may be over 11 million connections or edges and at level 9 there are over 80 million connections/edges. The equation that shows how many nodes are at each level may be defined as:

$${\sum }_{l = 1}^{m} {x}^{l - 1} n \qquad Equation ( 1 )$$

where l is the level and m is the level to go to. The equation for the edges may be defined as:

$${\sum }_{l = 2}^{m} {x}^{l - 2} n \cdot [ \frac{( x + 1 ) x}{2} ] \qquad Equation ( 2 )$$

Assuming that each manager's employees are not connected, then the overall degree of separation may be more than 2 in most cases. Overlaying multiple networks may give more connections and a lower degree separation. The network modeling or graph generation may be useful for graphically viewing one's network and more efficiently communicating. For example, in a direct sales or MLM business, the graphical representation of the network may be used for a variety of purposes, including communications, surveys, tracking, targeting, etc.

Combining different networks can lower the degrees of separation of nodes. For example, a work network may have connections in a hierarchy (boss-employee) that results in a higher degree of separation. For example, starting with three people who initially they each send a message to two people, who send it to two people. Getting from 15 to 20, the degree separation is five. However, considering additional connections between all those nodes can reduce the degree of separation. For example, using the device connections (i.e. people with the same smartphone or computing device) for those individuals may result in further connections. With a comparable number of connections between devices, the combination of the work network with the device network can result in a graph with a significantly lower degree of separation.

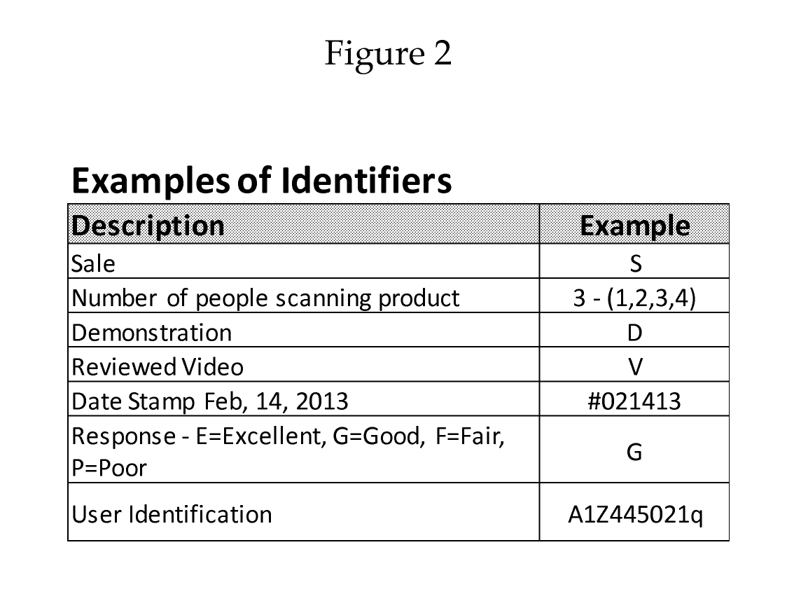

Using the above equations, the people being affected in a network may be tracked. By combining different types of networks and the connections in the network can be increased and the degree of separation decreased. Accordingly, any message started in the network can spread extremely quickly. As described with respect to FIGS. 2-5, a unique identifier (“ID”) may be assigned to each node for tracking the network and analyzing interactions in that network. For example, the unique IDs can be used to analyze how each network spreads the message individually and together. For example, the spread of a message in a work network may be slower than the spread of a message in a device network.

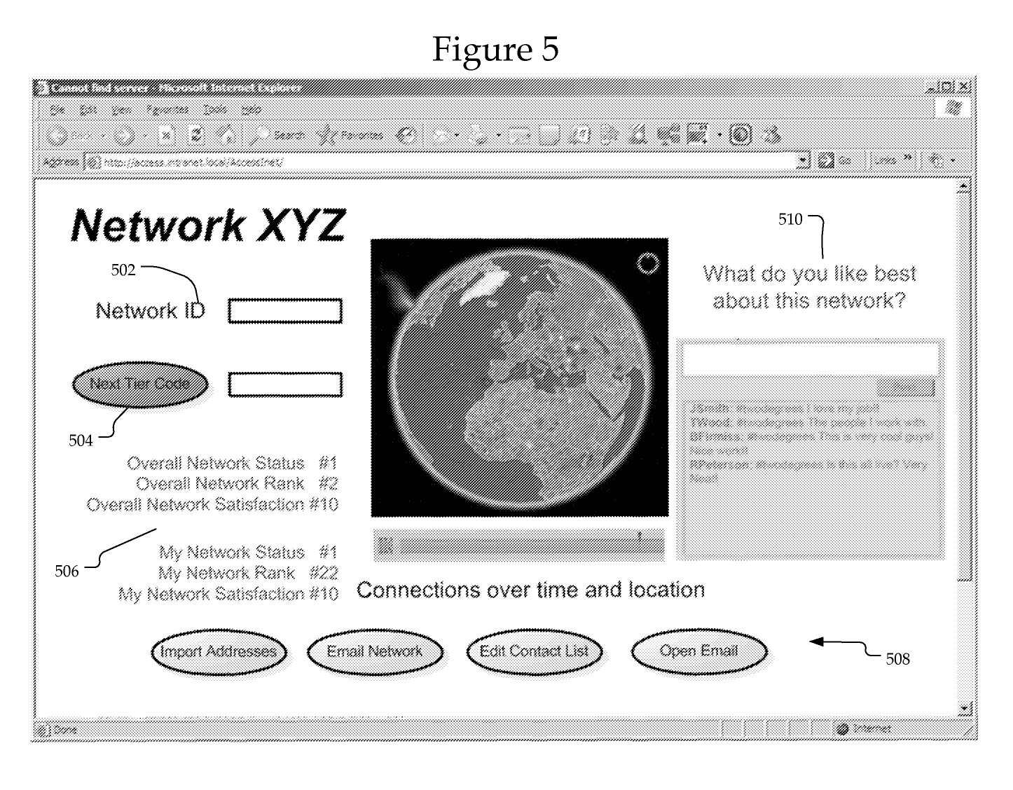

The network modeling, unique ID generation/assignment, and network tracking may be performed by a computer or computing device. The device may be part of a network (i.e. a computer network such as the Internet) for communicating information about the network and/or IDs. The computing system may utilize an interface (e.g. FIG. 5), such as web page, for providing access to the ID generation process and for providing information about network tracking.

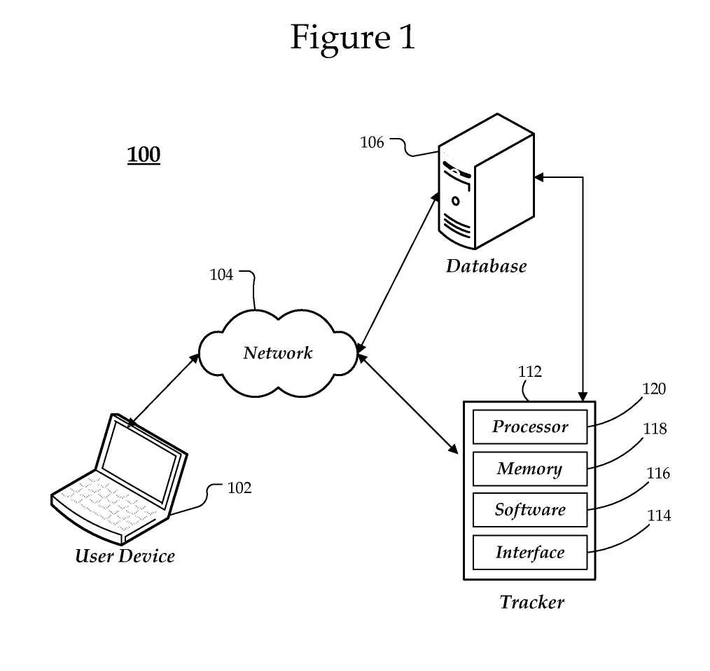

FIG. 1 illustrates a block diagram of an exemplary computing system 100. The system 100 may include functionality for network modeling, tracking, ID generation, and package tracking. In the system 100, a user device 102 is coupled with a database 106 through a network 104. As described below, network 104 is a computer network rather than the network of interconnected people/nodes. The tracker 112 may include or be coupled with a web server that distributes data from the network 104. The tracker 112 may be coupled with the network 104 and/or the database 106. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to the network 104, such as the Internet. Examples of a user device include, but are not limited to, a personal computer, personal digital assistant (“PDA”), cellular phone, or other electronic device. The user device 102 may be configured to allow a user to interact with the database 106, the tracker 112, the interface (e.g. FIG. 5), or other components of the system 100. The user device 102 may include a keyboard, keypad or a cursor control device, such as a mouse, or a joystick, touch screen display, remote control or any other device operative to allow a user to interact with the database 106 and/or the via the user device 102. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla). The data displayed by the browser may include requests for an ID, ID information, network tracking, and/or tracking data. In an alternative embodiment, software programs other than web browsers may also display the data over the network 104 or from a different source.

The database 106 may store network or tracking information. A generated network (i.e. the nodes and connections) may be stored in the database 106 that is accessed by the tracker 112. In one embodiment, an interface is provided by or through the tracker 112 (e.g. the interface shown in FIG. 5) that is provided to the user device 102. Any information received from or provided by the tracker 112 through the interface may be stored in the database 106. In one embodiment, the database 106 may be combined with or part of the tracker 112, such as the memory 118.

The tracker 112 may be a computing device for performing network tracking related functions. Any of the ID generation, ID tracking, network modeling, network tracking, and/or package/product monitoring/tracking may be performed by the tracker 112. The tracker 112 may include a processor 120, a memory 118, software 116 and an interface 114. In alternative embodiments, the tracker 112 may be multiple devices to provide different functions and it may or may not include all of the interface 114, the software 116, the memory 118, and/or the processor 120.

The interface 114 may be a user input device or a display. The interface 114 may include a keyboard, keypad or a cursor control device, such as a mouse, or a joystick, touch screen display, remote control or any other device operative to allow a user or administrator to interact with the tracker 112. The interface 114 may communicate with any of the user device 102, the database 106, and/or the tracker 112. The interface 114 may include a user interface configured to allow a user and/or an administrator to interact with any of the components of the tracker 112. For example, the administrator and/or user may be able to access a unique ID interface (e.g. FIG. 5) through the interface 114. The interface 114 may include a display coupled with the processor 120 and configured to display an output from the processor 120. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing data.

The processor 120 in the tracker 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a (computer) network, including but not limited to the network 104. For example, the tracker 112 may be coupled with the database 106 and/or the user device 102 through a network. Accordingly, any of the components in the system 100 may include communication ports configured to connect with a network. The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

The system described herein may allow access to a unique ID. The access may be through an interface, such as a website, smartphone app, or SMS repeater application (e.g. FIG. 5). The interface may be used to send messages with your unique ID to any number of your networks. The message received by will also receive an ID that they can then share with their network. The proliferation of a message or data through a larger network may continue dependent on the significance of the network and/or communications topic. For example, a user can send a message to one or more of his/her networks asking everyone that believes in a charity to share best experiences with that charity. If everyone shares and passes these additional IDs along with the message, then the growth and dynamics of this network can be monitored and tracked. This is one example of network tracking, which may include any monitoring of the network, including data/message proliferation through the network.

An interface or application may be used by a network user to start a message by sharing it with a starting network of users. That starting ID may be added to as each layer of the network grows and expands with codes at each layer of the network. The network tracker may monitor or receive data/messages regarding each time the message is sent. The use of IDs may make this network tracking possible, allowing for the tracking not only of the IDs, but also of timing, global location, age, ethnicity, sex, interests and more. FIGS. 2-4 illustrate exemplary data/information than can be combined with the ID for tracking Once the network is formed it may be stored by the tracker and/or on the web. The network can be visualized and utilized to measure and analyze how the topic moved through the network. Even the speed of the network can be analyzed. For example, a user may know that a message/communication about charity may flow faster and farther through that user's work network rather than that user's friend network. A company may be able to form and track different networks of employees or customers for identifying the best communication method for employees or for identifying the best way to market to customers.

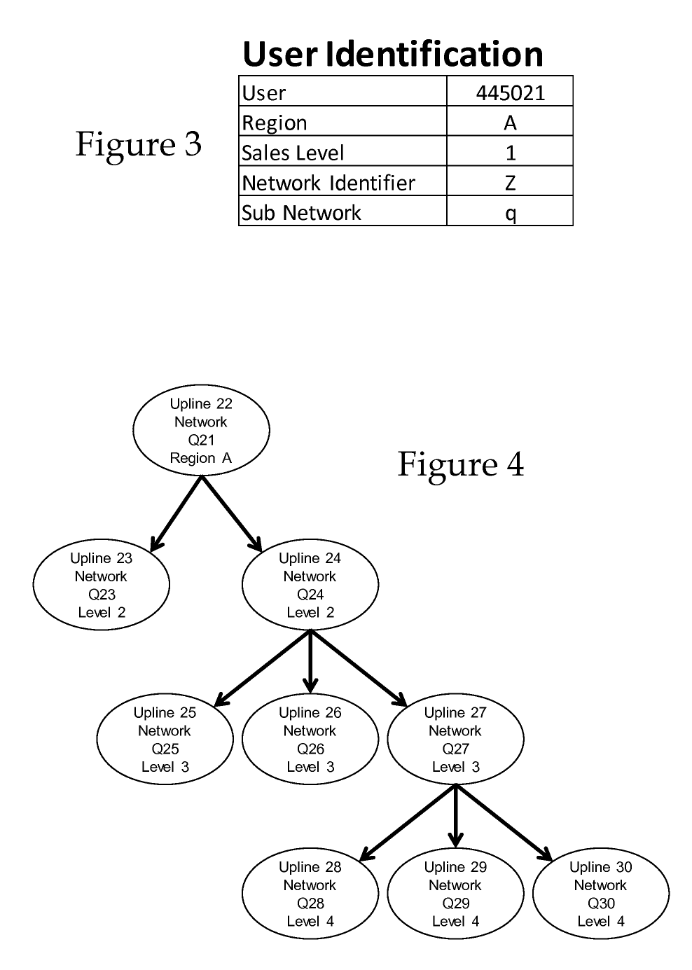

FIGS. 2-4 illustrate the ID features that allow messages to be shared with a network. The ID may be an alpha-numeric string whose values reflect information as discussed below. FIG. 2 illustrates exemplary identifier (ID) information that may include a user identification field that may identify a user as described below with respect to FIG. 3. This user identification may be different for each user/node in a network. There may be additional preamble/prefix and/or postamble/suffix information that is added to this user identification. Examples include an indication of sale. The unique ID may include various fields that indicate data about the node. In the example of product tracking described below with respect to FIG. 10, there may be: 1) an “S” at a particular field to indicate a sale.; 2) an indication of the number of people interacting with a message or product; 3) an indication of whether a demonstration of the product has occurred; 4) an indication whether a review of video has occurred; 5) a date stamp of origination and/or interaction; and 6) a response to the product from a potential consumer. This information may be added to the unique ID so that the person/product associated with the unique ID is further described.

FIG. 3 illustrates user identification information. The unique ID may include a user identification field. FIG. 3 illustrates exemplary elements for the user identification field. The user may be identified to distinguish each node. A region may identify a location and may be used for identifying and tracking a regional network. A network identifier and/or sub network may identify a particular, network or networks that the node belongs to. A sales level may be an example of information relevant within an MLM business to indicate where within the MLM that a particular user is located. There may be additional fields/information that is part of the user identification, including but not limited to demographics or other information about the user/product that is identified.

FIG. 4 illustrates an exemplary network for the identifier information from FIG. 3. FIG. 4 may be one example of an MLM network with uplines and downlines for different nodes. In particular, FIG. 4 may utilize the fields shown in FIG. 3. Each node may have a separate unique ID and a separate user identification field. The user identification may include a user identifier, a region identifier, a sales level (e.g. levels 1-4), a network identifier and/or a sub network. This may be an exemplary structure of the unique ID and user identification field for an MLM network.

FIG. 5 illustrates an exemplary interface for interacting with the unique identifier and tracking a network. The Network XYZ is an example that shows a collection port for a tracking campaign. For example, a user (e.g. a seller in a direct sales network) may be able to convey a marketing story (i.e. a description about a favorite product a philanthropic effort from your direct sales company) to your community. Everyone can share it to their network and they in turn share their ideas/stories. The tracker watches the layers and monitors a snapshot of this network as it builds and explodes. It may take a special event or question to set this off but the tool shown in FIG. 5 may be a portal that can track such an event by passing a email with a network ID code and watching each subsequent layer of the network worldwide.

The interface shown in FIG. 5 may be for the tracking system and may include a software interface. In one embodiment, the interface may be a smartphone application that a user upon receipt of a message from another user can download and run. The smartphone application may access contacts (e.g. phone contacts, Facebook contacts, LinkedIn contacts, etc.) to provide a mechanism for further distributing a message and for identifying/expanding one's network. Any information stored with or provide by the interface may be from database 106.

In FIG. 5, the interface is illustrated as a web page, but that is merely one embodiment. The tracking system receives information from and displays information to this interface. It starts with the tier one code that gets shared with web address for access and tracking. In block 502, a network ID is entered. That network ID may be the unique ID for the referrer. For example, a referrer could encourage his/her contact list (e.g. Facebook friends, Twitter followers, LinkedIn contacts, etc.) to go to the website and enter the codes so they each have a unique ID. The unique ID may include information identifying the referrer.

Clicking Next Tier Code in block 504 can generate another unique ID for a different node in the network that is connected to the referrer node. In block 506, information about the network is displayed. Additional options, such as adding contacts, emailing the network, editing contacts, or opening email are shown in block 508. There may be a commenting section in block 510 for members of the network to provide questions/comments about the network. The interface may be connected to an address book or other contact lists, including social media contacts (e.g. Facebook, Twitter, LinkedIn, etc.).

Upon receipt of the network ID in block 502, the interface parses the preamble/postamble to identify tracking information and utilizes the user identification field to identify the user. A unique ID may be generated for another user that identifies the referrer as par to the preamble/postamble. This can be used as part of a campaign or message that flows through a network. Once the campaign is started, the ID increments by person and by level of the network. Personal data or survey data may be transferred within the network and then sent or flashed to the website.

This website interface may be used to assign unique identification codes to each person based on who sent them to the website. Then they are given a unique code to use (pass along) for anyone in there network. This can repeat until a structure of a network forms. This network may be utilized for several unique advantages within the direct sales, MLM, and/or retail industry. This concept may help with tracking and monitoring the integrity and communications of a personal network. In one embodiment, satisfaction or opinions may be tracked using the unique IDs to identify members of the network and using the interface to receive the indication of satisfaction/opinion. This satisfaction/opinion survey may be tracked throughout the network.

The interface may model one's network. The modeling may be a graphical illustration of nodes and connections between those nodes. Accordingly, a user can see the global outreach and scope of their different networks or combinations of networks. The combination of networks may be used to generate a new super-hybrid network (e.g. an overall network that encompasses all networks and contacts) that connects multiple networks (e.g. pulls in Facebook, Twitter, LinkedIn, etc.). The degrees of separation may be illustrated by the connections. This could be part of an advertising campaign to touch the three degrees of separation. Alternatively, this can be used to expand a person's network and be used to generate candidate prospects for business.

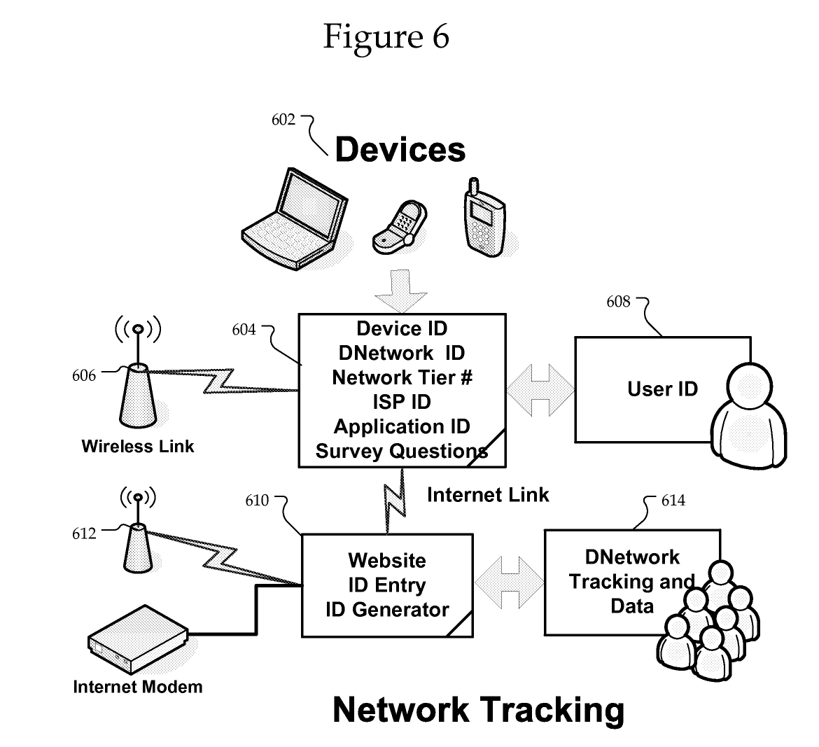

FIG. 6 illustrates a block diagram of exemplary network tracking. In particular, FIG. 6 illustrates how unique ID's can be shared through various communication mediums for providing network information. The communication may be anonymous but may be used for tracking usage. Devices 602 may include information 604 including a unique ID that includes information for: 1) the device identification; 2) the network identification; 3) a network tier/level; 4) an internet service provider ID; 5) an application ID; and/or 6) survey questions. The user ID 608 for each user of the device may also be included. The wireless link 602 may provide a connection to the wireless link and modem 612 for the website interface 610. The website interface 610 (e.g. FIG. 5) may include ID entry and ID generation that is used for network tracking 614.

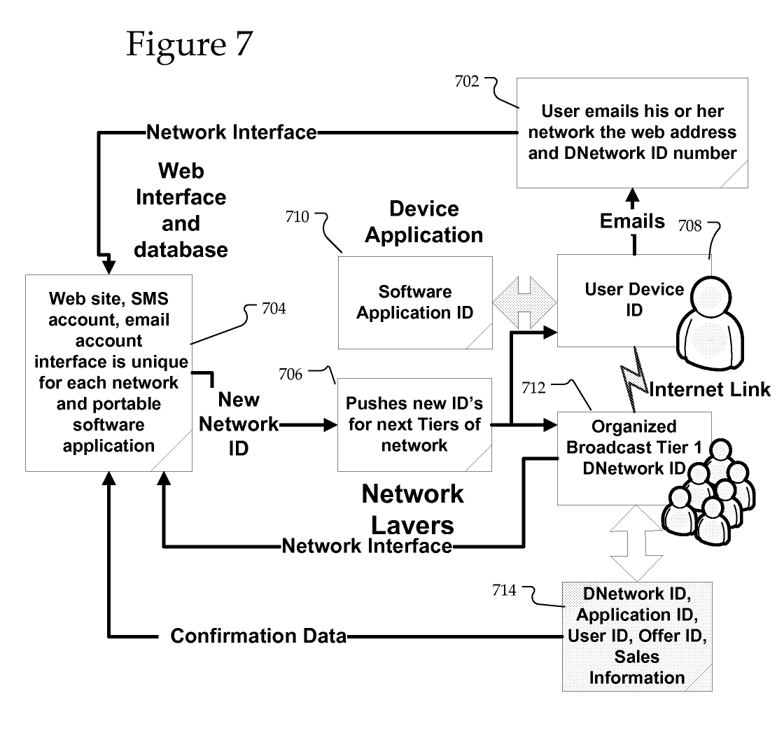

FIG. 7 illustrates a business example for network tracking. The example in FIG. 7 shows the ability to apply the network tracker to a direct sales network. Each person at each sales level has a network of sales people. They also have layers of sales people. Accordingly, the direct sales network structure allows for an organized effort to extract friends and contacts from the organization. FIG. 7 illustrates an opportunity for that network layer and connections. The network layers are organized and specific Network Layer ID's may be established to identify the root and branches for each layer while identifying the additional opportunity of the personal network not in the business. This ID system allows offers to be pushed at any layer or within any network. It allows tracking of sales, training, product consumption and sales opportunity at each level. In particular, FIG. 7 illustrates the identification of the network and its branches to allow visibility to its structure. Based on this organization, a user can service of various levels without having to address the whole. This resolution of networks may be a key aspect of direct sales and improving business by supporting various layers of the network at different levels to build businesses within the network.

Applications for computing devices or smartphones can be created and downloaded for specific uses. Churches, business, direct sales and marketing can all have software applications that enable that business tracking. The specific application may all connect to the same or similar data sources for compiling and tracking larger networks. In block 702, a user emails one or more of their networks. The email includes tracking information (e.g. web address, network identifier, and ID number) that is used by the network interface in block 704. A new ID is generated for the user that accesses the interface in block 706. The user with the new ID from block 708 may then email his/her contacts in block 702 to fill out the network. This may be performed with a device application 710 that includes a software application ID. In block 712, there may be an organized network that is received when new IDs are pushed in block 706. Information from this organized network 712 may be sent to the website interface 704 for confirmation in block 714.

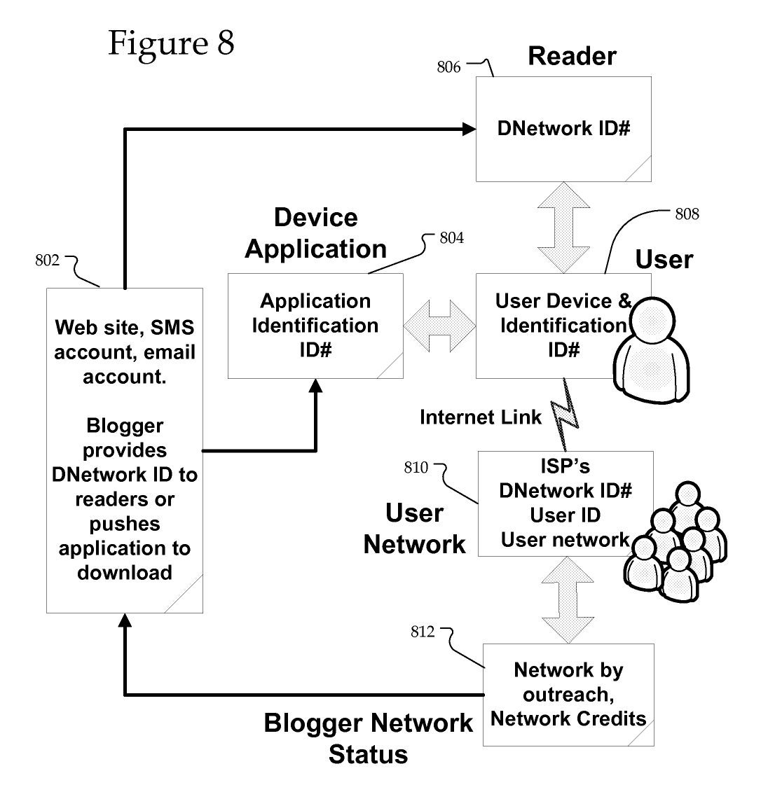

FIG. 8 illustrates a blogger example for network tracking FIG. 8 shows how a blogger can use this tool to check follower status and network reach. This blogger example is similar to the business network example in FIG. 7 except it illustrates a “flatter” blogger network as compared with the greater depth of a direct sales network. FIG. 8 illustrates the network following the blogger or social network broadcaster. The network credits may be established by linking or sharing the network ID attached to documents. This may show the outreach by user and allows super users and target user groups to be defined and credits to identify a share network threshold within these users and networks. Tracking and understanding of these network layers and sharing helps to define user communities by article and interest. The reader may be software that embeds the ID with the document and decodes the ID for tracking a series of shared pathways showing source and shared pathway. In particular, the interface 802 is used for receiving information from a device application ID 804. The user 808 receives a network ID 806 from the interface 802. The user's 808 network 810 is connected with the blogger network status 812 that provides information from that network 810 to the interface 802. Through a network identification upon reading in block 806, the user 808 and his/her network 810 may be identified in the interface 802.

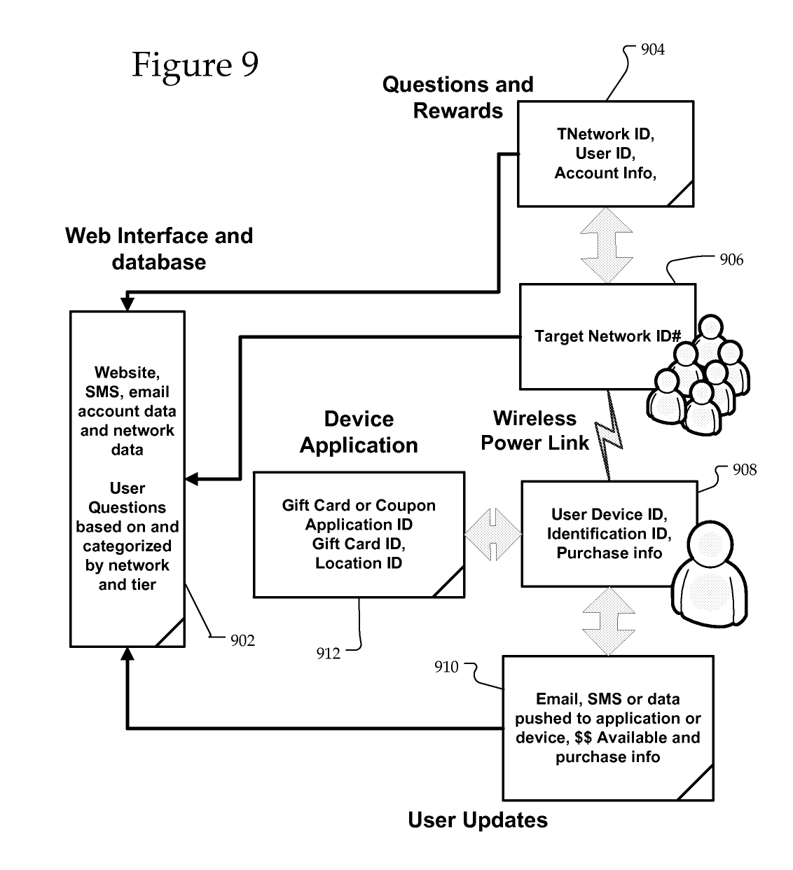

FIG. 9 illustrates a survey example for network tracking. This survey example illustrates an application where coupons or gift cards within a network can be associated with the layers of a network. By requesting a survey and getting feedback and interest from specific communities, these communities may be optimally targeted based on interests in a particular topic. The shared content and answers to the survey may be tracked, and shared points may be awarded that then drive rewards based on value to the business by enabling coupons or gift cards based on impact.

FIG. 9 shows how a network may be used to track levels or tiers of a network while asking questions at each tier. Each of these tiers can be utilized to ask questions specific to that tier. This may be helpful in a business to monitor management versus factory staff. It may be useful to know of any significant morale changes at a particular tier. The interface is shown in block 902. Questions and rewards 904 are asked of a target group 906. The target group 906 utilizes a device 908 to provide user updates 910. The device 908 may be used for device applications 912.

FIG. 10 illustrates identifier tagging of a product/package for tracking within a network. The product can be tracked and a network can be established based on interactions with that product. Each interaction with the product can be tracked using the ID of each person that scans the package. The tag may be read so that someone can identify all interactions with the product. Likewise, each interaction with the product can be recorded with the tag. Through the user of unique IDs as discussed above, the interactions with the product can be recorded and accessed. This information may be accessible through an interface by utilizing the product unique ID (e.g. UPC code of the product or QR code) or the unique ID of someone who interacted with the product.

The tag may track packages/products as an NFC or RFID tag with a tracking component. There is an NFC package that can read this additional data and can also write to the tag. This records and can share who interacts with a particular package. For example, there may be an Amway app that does the communication with the tag on a package. The product packaging may be tagged with the unique ID for tracking the network and providing additional information about the product and those that interact with the product. Encryption for the user identification may be used to prevent fraud.

An MLM or retail company may use network tracking to track and record product demos. For example, at a trade show, all interactions with a product are recorded in the tag. This feedback can be valuable for evaluating the product and identifying a target audience for the product. This can also be used to monitor/track sales within a direct sales or MLM network. The tracking may be over the network's upline and downline. There is an interface (e.g. website or smartphone application) which tracks who receives/reads each of the product tags. The website parses the preamble/postamble to see who receives/reads each tag. The unique ID for a product may have product identification and may include additional information as the preamble/postamble to the ID. The additional information may be info about the data transferred, or the person receiving/reading it (i.e. interaction). The tracker takes that information and the interactions and displays them on the interface. In the case of a website interface, the URL for the website may be included with the information stored on and transmitted by the tag.

In particular, FIG. 10 illustrates a 1^{st} Read in which a unique ID of the product (e.g. product URL) is read and then written to the tag on the product including the unique ID of the user performing the scanning (i.e. 1stID). A 2^{nd} Read of the product URL results in the tag being written with the unique ID of the second user (i.e. 2ndID) being added to the product tag. A 3^{rd} Read of the product URL results in the tag being written with the unique ID of the third user doing the scanning (i.e. 3rdID) being added to the product tag. Accordingly, the product tag includes the product identifier (e.g. URL) along with the three user IDs of those that scanned the product. Finally, at a sale of the product, the tag of the product is updated with an indication of the sale and a sale ID.

In one embodiment, this scanning may be automated such that when a mobile device of a user (which stores that user's unique ID) is within range of the product, that information is recorded with the product. This may be through any form of wireless communication including but not limited to NFC or Bluetooth. For example, setting your smartphone on a package may cause the tag from the package to be read and may immediately provide information on the smartphone. That information may include tracking data, such as identification of other users through the unique IDs that were recorded on the tag. The information associated with those IDs (e.g. preamble/postamble info) may provide additional tracking information. The information may include a product rating or analysis from each user. At a trade show, a user could test out multiple products and rate each one, with the rating being stored as part of the information on the tag. In one embodiment, this testing process may result in compensation for the user.

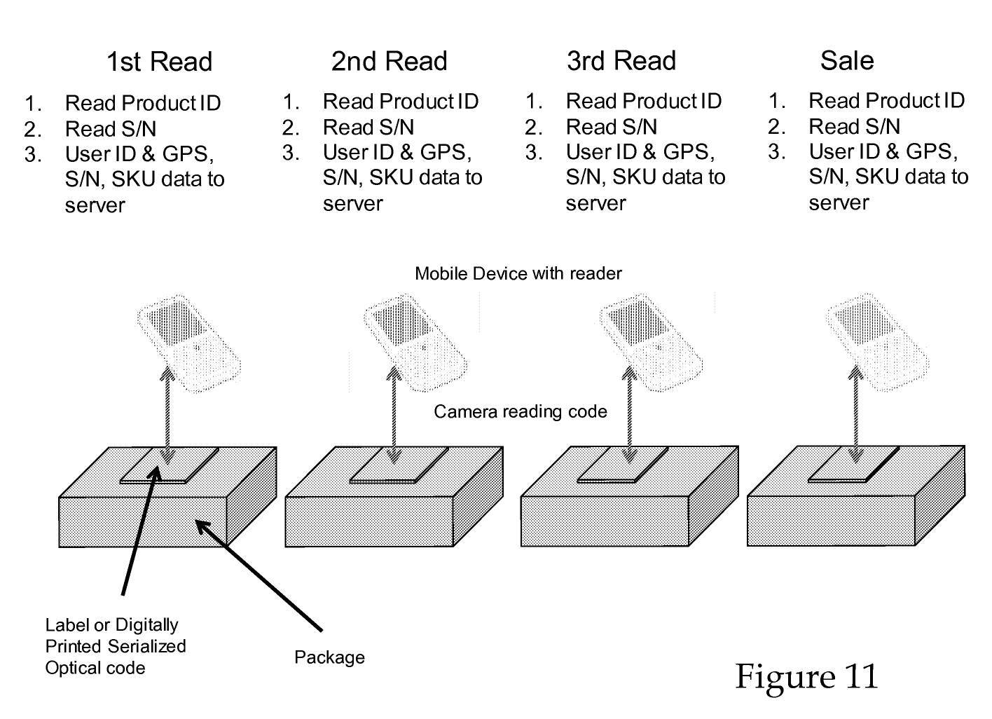

FIG. 11 illustrates another embodiment of identifier tagging of a product. FIG. 10 illustrated the use of NFC for tagging, while FIG. 11 illustrates using an optical code for tagging. The optical code may include a universal product code or two-dimensional code (e.g. QR code) that identifies information. For example, the optical code may encode a product identifier (ID), a serial number, a user identifier, universal resource locator (URL), location information (e.g. GPS), and/or other product information (e.g. SKU). The optical code may be a concentric code that has both. This provides several uses for the code and enables several business processes for tracking a sales network and tracking where the product gets used.

With the introduction of digital printing presses new printing capabilities maybe utilized. One of these capabilities may include providing digital data in combination with static data which is part of the optical code. The code may be labeled or digitally printed or serialized on the package and read from the mobile device (e.g. a camera on the mobile device can read the optical code). Accordingly, the addition of these labels to the packages may allow for network tracking. As described, the network may be a direct sales network.

Each time this code is read it may direct the user to product specific information. Ordering details, manufacturing history and details, product videos, sales promotional videos, service data, warranty data, and more may all be provided through the optical code. This code allows a direct sales company to hang additional data off this transactional series of events. New questions can be asked about how many hands does a product go through, and how long does a sale take. Further, information such as the regional latitude, disposition of products being shipped in country, and where products end up can also be tracked. In one example, this information may be used for fighting counterfeit products.

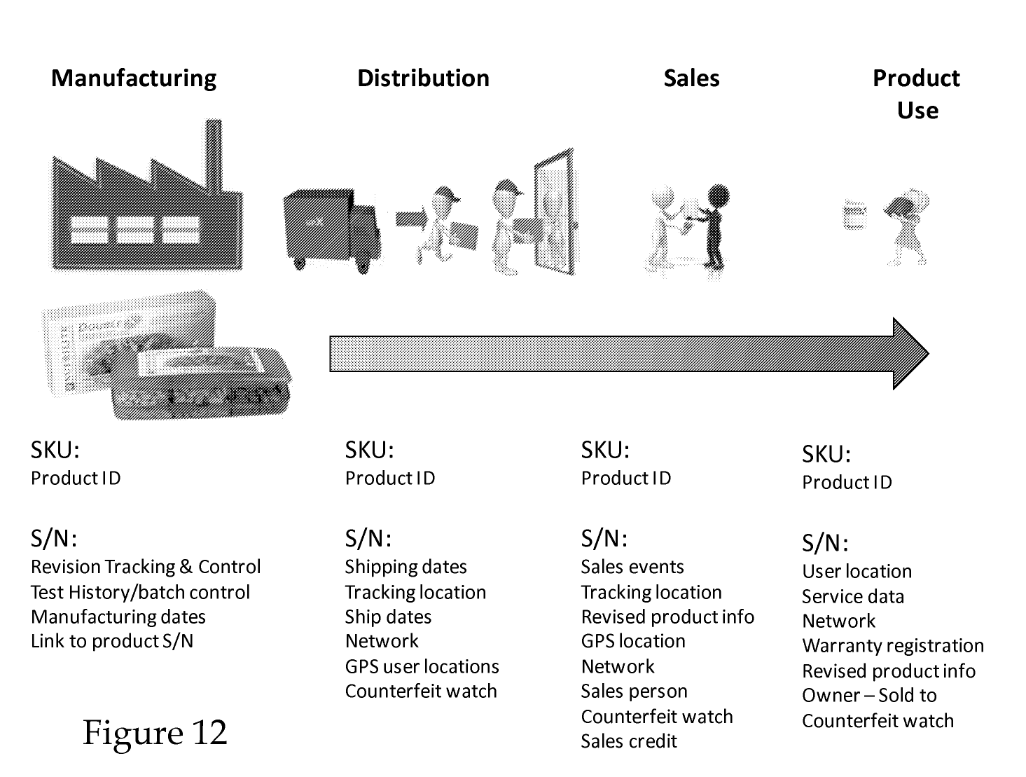

FIG. 12 illustrates an exemplary flow in a sales network. FIG. 12 is an example of the data that can be connected when there is a common connection (i.e. universal tracking) to the sales network. The unique ID number along with combining a connection to the sales person and network enables a data point unique to the direct sales network. Scanning a product for a sales promotion video, sales training video, posting a sale or requesting sales credit are all examples of tracking and interface opportunities within the network that are enabled through this system.

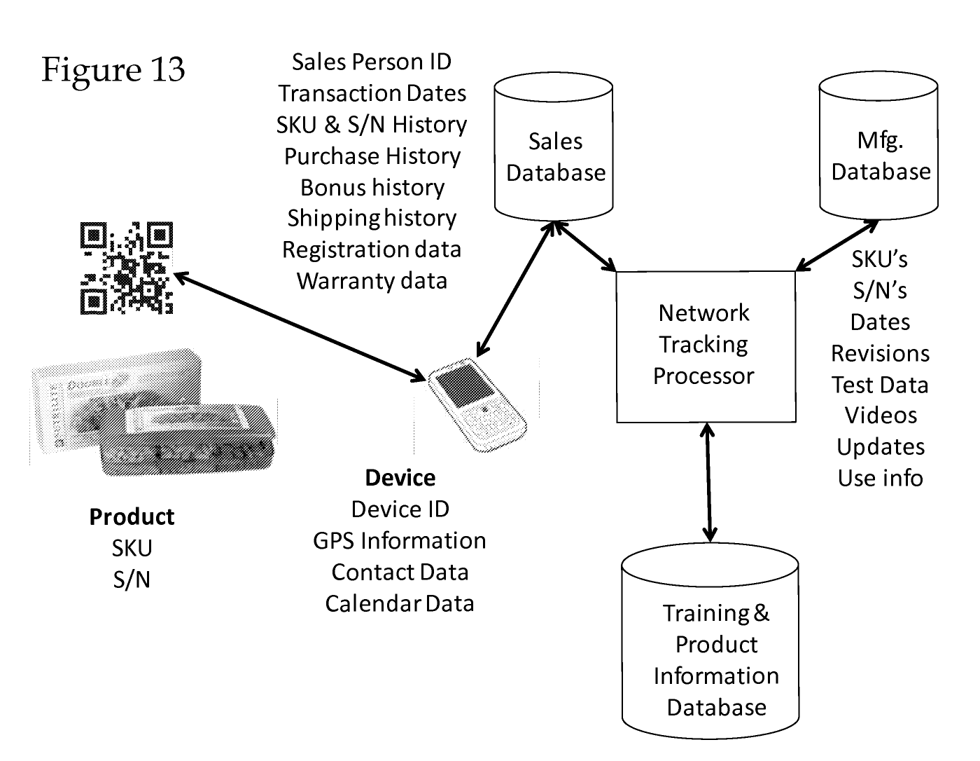

FIG. 13 illustrates the linking of data in a sales network. Product information may be conveyed to a user device (e.g. mobile phone) such as through an optical code. The user device may include information about the device and/or user (e.g. GPS, contacts, calendar info, etc.). The data may be part of a sales database whose information is used by a network tracking processor for tracking. A manufacture database may include additional product information/marketing/data about a particular product. A training and product information database may be a part of the manufacture database or may be separate for holding different information. Data such as the tracking and identification of an end user, sales, and resale can be tracked to establish a chain of a product. For example, this data within a direct sales network can be used to link products with the same serial number (S/N) and/or SKU, which can be flagged as potentially counterfeit. The user can track a particular product being manufactured. Establishing this network may allow promotions and revision data to be user, region, network, and product, specific. By offering sales videos or promotional media, there may be interface to link to products through a 2D code and further allow tracking metrics throughout a direct sales network.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for modeling a network comprising:
receiving an indication of contacts from an originating node of the network, wherein the originating node is assigned a unique identifier;
assigning each of the contacts to a node coupled with the originating node in the network with a unique identifier, wherein the unique identifier for each of the nodes includes information about the contact, further wherein the information includes an identification of the originating node; and
utilizing the unique identifier at an interface to provide the information for the nodes.

2. The method of claim 1 wherein the unique identifier comprises an alpha-numeric string.

3. The method of claim 2 wherein the unique identifier comprises information identifying a sales level within a multi-level marketing system.

4. The method of claim 1 wherein the originating node is associated with a user and the contacts comprise other users associated with the user.

5. The method of claim 4 wherein the identification of the originating node comprises identifying the user.

6. The method of claim 1 wherein the nodes comprise locations on the network.

7. The method of claim 1 wherein the network comprises the Internet and the nodes comprise devices coupled with the Internet.

8. The method of claim 1 wherein the information for the nodes provided at the interface comprises an identification of the contact assigned to the node.

9. A method for tracking throughout a network comprising:
mapping the network as a plurality of interconnected nodes;
establishing a unique identifier for each of the nodes in the network;
modifying the unique identifier for tracking within the network; and
providing an interface for accessing the tracking with the unique identifiers.

10. The method of claim 9 wherein the network comprises the Internet.

11. The method of claim 10 wherein the interface comprises a website into which the unique identifier is entered and the tracking is then displayed on the website.

12. The method of claim 10 wherein each of the nodes comprises a location on the network

13. The method of claim 12, wherein the nodes each comprise one or more websites.

14. The method of claim 9 wherein the unique identifier comprises an alpha-numeric string.

15. The method of claim 14 wherein the unique identifier comprises information identifying a sales level within a multi-level marketing system.

16. The method of claim 14 wherein the unique identifier comprises information for the tracking.

17. The method of claim 16 wherein the information for the tracking comprises an indication of each of the nodes in the network through which the unique identifier travels.

18. A method for tracking and monitoring a package comprising:
providing an identifier tag on the package, wherein the identifier tag can be written to and read from;
writing to the identifier tag to record an interaction with the package, wherein the recording comprises information about the interaction; and
reading the identifier tag to retrieve information about the package, interactions with the package, and the information about the interactions.

19. The method of claim 18 wherein the identifier tag comprises a unique identifier that identifies the package.

20. The method of claim 18 wherein the interaction comprises a node through which the product passes.
